(19) United States
(12) Patent Application Publication
(10) Pub. No.: US 2025/0062504 A1
(43) Pub. Date: Feb. 20, 2025

(54) ELECTRODE ASSEMBLY FOR SECONDARY BATTERY

(71) Applicant: Samsung SDI Co., Ltd., Yongin-si (KR)

(72) Inventors: Hyung Dong LEE, Yongin-si (KR); Jae Hyung KIM, Yongin-si (KR); Seung Il KIM, Yongin-si (KR)

(21) Appl. No.: 18/637,285

(22) Filed: Apr. 16, 2024

(30) Foreign Application Priority Data
Aug. 17, 2023 (KR) 10-2023-0107581

(51) Int. Cl. H01M 50/538; H01M 10/04; H01M 10/647

(52) U.S. Cl. CPC H01M 50/538; H01M 10/0431; H01M 10/647

(57) ABSTRACT

An electrode assembly for a battery includes: a positive electrode plate including a positive electrode current collector plate, a positive electrode active material layer on a surface of the plate, at least one uncoated portion at which no positive electrode active material is applied, and at least one positive electrode tab electrically attached and coupled to the uncoated portion, and protruding upwardly from an upper portion of the electrode assembly; a negative electrode plate including a negative electrode current collector plate, a negative electrode active material layer on a surface of the plate, at least one uncoated portion in which no negative electrode active material is applied, at least one negative electrode tab electrically attached and coupled to the uncoated portion, and protruding downwardly from a lower portion of the electrode assembly; and a separator between the positive electrode plate and the negative electrode plate.

### CROSS-REFERENCE TO RELATED APPLICATION

The present application claims priority to and the benefit of Korean Patent Application No. 10-2023-0107581, filed on Aug. 17, 2023, in the Korean Intellectual Property Office, the entire disclosure of which is incorporated herein by reference.

### BACKGROUND

### 1. Field

The present disclosure relates to an electrode assembly for a secondary battery.

### 2. Discussion of Related Art

Unlike primary batteries, which cannot be recharged, secondary batteries are batteries that can be charged and discharged. Low-capacity batteries, in which a single battery cell may be packaged, may be used in small and portable electronic devices, such as mobile phones and camcorders. Large-capacity battery modules in battery pack units in which dozens of battery packs are connected may be widely used as power sources for driving motors in hybrid vehicles, electric vehicles, and the like.

Lithium-ion batteries, which account for most of the secondary battery market, may be divided into cylindrical-, prismatic-, and pouch-type batteries depending on their shape. As electronic devices become smaller, smaller batteries are generally desirable, and desirability for pouch-type secondary batteries is increasing.

Pouch-type secondary batteries may be manufactured in a flexible pouch form, so their shape is relatively free and their weight is light, which may enable slimming, and the reduction of the weight of portable electronic devices. Recently, as the pouch-type secondary batteries have superior space utilization compared to cylindrical or prismatic-type batteries, the pouch-type secondary batteries are being widely applied to middle- or large-sized batteries of electric vehicles. To satisfy preferences for high output of hybrid vehicles or electric vehicles, the voltage of the battery pack may be increased by connecting several pouch-type batteries in series.

In this regard, if a battery pack is formed by connecting a plurality of pouch-type battery cells in series, an electrode assembly for a secondary battery that has a structure allowing stable and suitable electrical connection between electrode tabs of adjacent battery cells is desirable.

### SUMMARY

The present disclosure is directed to providing a secondary battery having an electrode assembly with an electrode tab structure in which two or more unit battery cells can be connected to each other in series to exhibit high voltage and high output characteristics.

Embodiments of the present disclosure may be directed to an electrode assembly applied to a pouch-type secondary battery, and may relate to an electrode assembly in which electrode tabs are provided on both ends of the electrode assembly to enable serial connection between battery cells.

According to an aspect of the present disclosure, there is provided an electrode assembly for a secondary battery, which includes a positive electrode plate including a positive electrode current collector plate, a positive electrode active material layer on a surface of the positive electrode current collector plate, at least one uncoated portion at which no positive electrode active material is applied, and at least one positive electrode tab electrically attached and coupled to the at least one uncoated portion of the positive electrode plate, and protruding upwardly from an upper portion of the electrode assembly, a negative electrode plate including a negative electrode current collector plate, a negative electrode active material layer on a surface of the negative electrode current collector plate, at least one uncoated portion in which no negative electrode active material is applied, at least one negative electrode tab electrically attached and coupled to the at least one uncoated portion of the negative electrode plate, and protruding downwardly from a lower portion of the electrode assembly, and a separator between the positive electrode plate and the negative electrode plate.

The at least one uncoated portion of the positive electrode plate may include uncoated portions respectively at a winding start end and at a winding finish end of the positive electrode plate, and the at least one uncoated portion of the negative electrode plate may include uncoated portions respectively at a winding start end and at a winding finish end of the negative electrode plate in a winding direction.

The at least one positive electrode tab may be at the winding start end of the positive electrode plate in the winding direction, and the at least one negative electrode tab may be at the winding start end of the negative electrode plate in the winding direction.

The at least one positive electrode tab may be at the winding finish end of the positive electrode plate in the winding direction, and the at least one negative electrode tab may be at the winding finish end of the negative electrode plate in the winding direction.

The at least one positive electrode tab at the winding start end of the positive electrode plate in the winding direction, and the at least one negative electrode tab may be at the winding finish end of the negative electrode plate in the winding direction.

The at least one positive electrode tab may include positive electrode tabs respectively at the winding start end and at the winding finish end of the positive electrode plate in the winding direction, and the at least one negative electrode tab may include negative electrode tabs respectively at the winding start end and the winding finish end of the negative electrode plate in the winding direction.

The at least one uncoated portion of the positive electrode plate may further include an uncoated portion at a center of the positive electrode plate, the at least one uncoated portion of the negative electrode plate may further include an uncoated portion at a center of the negative electrode plate, the at least one positive electrode tab may be at the center of the positive electrode plate, and the at least one negative electrode tab may be at the center of the negative electrode plate.

The at least one uncoated portion of the positive electrode plate may further include an uncoated portion at a center of the positive electrode plate, the at least one uncoated portion of the negative electrode plate may further include an uncoated portion at a center of the negative electrode plate, the at least one positive electrode tab may include positive electrode tabs respectively at the winding start end, at the winding finish end, and at the center of the positive electrode plate in the winding direction, and the at least one negative electrode tab may include negative electrode tabs respectively at the winding start end, at the winding finish end, and at the center of the negative electrode plate in the winding direction.

### BRIEF DESCRIPTION OF THE DRAWINGS

The above and other aspects of the present disclosure will become more apparent to those of ordinary skill in the art by describing embodiments thereof in detail with reference to the accompanying drawings, in which:

FIG. 1A is a perspective view illustrating a state before an electrode assembly of a pouch-type secondary battery is wound;

FIG. 1B is a perspective view illustrating a state in which the electrode assembly of FIG. 1A is wound;

FIG. 2 is a set of an exploded perspective view, and a wound cross-sectional view, of an electrode assembly according to one or more first embodiments of the present disclosure;

FIG. 3 is a set of an exploded perspective view, and a wound cross-sectional view, of an electrode assembly according to one or more second embodiments of the present disclosure;

FIG. 4 is a set of an exploded perspective view, and a wound cross-sectional view, of an electrode assembly according to one or more third embodiments of the present disclosure;

FIG. 5 is a set of an exploded perspective view, and a wound cross-sectional view, of an electrode assembly according to one or more fourth embodiments of the present disclosure;

FIG. 6 is a set of an exploded perspective view, and a wound cross-sectional view, of an electrode assembly according to one or more fifth embodiments of the present disclosure; and

FIG. 7 is a set of an exploded perspective view, and a wound cross-sectional view, of an electrode assembly according to one or more sixth embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In one or more embodiments, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In one or more embodiments, in the present specification, when a portion of a layer, a film, an area, a plate, or the like is formed on another portion, a forming direction is not limited to an upper direction but includes forming the portion on a side surface or in a lower direction. In one or more embodiments, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

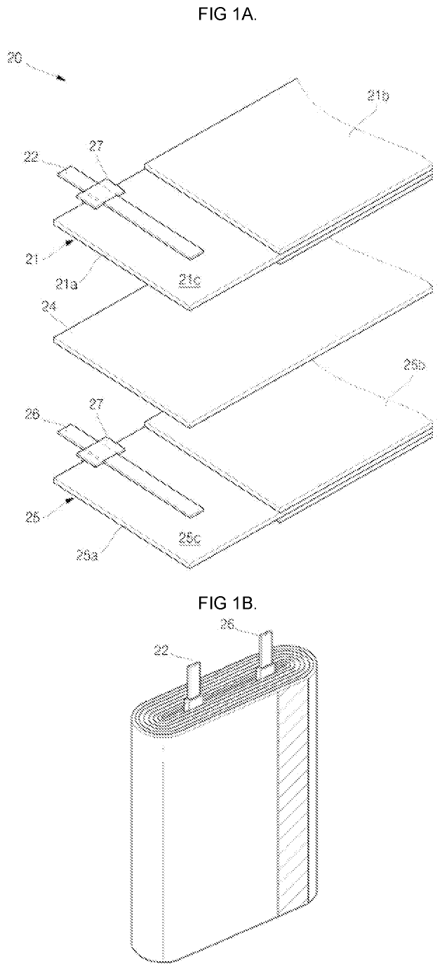

FIG. 1A is a perspective view illustrating a state before an electrode assembly of a pouch-type secondary battery is wound, and FIG. 1B is a perspective view illustrating a state in which the electrode assembly of FIG. 1A is wound. The pouch-type secondary battery includes an electrode assembly 20, and may include a pouch for accommodating the electrode assembly.

First, as shown in FIG. 1A, the electrode assembly 20 includes a positive electrode plate 21, a negative electrode plate 25, and a separator 24 interposed between the positive electrode plate 21 and the negative electrode plate 25.

The positive electrode plate 21 includes a positive electrode current collector 21a, and a positive electrode active material layer 21b coated on at least one surface of the positive electrode current collector 21a. The positive electrode plate 21 also includes a positive electrode uncoated portion 21c in which the positive electrode active material layer 21b is not formed on the positive electrode current collector 21a. A positive electrode tab 22 is attached to the positive electrode uncoated portion 21c.

Similarly, the negative electrode plate 25 includes a negative electrode current collector 25a, and a negative electrode active material layer 25b coated on at least one surface of the negative electrode current collector 25a. The negative electrode plate 25 includes a negative electrode uncoated portion 25c in which the negative electrode active material layer 25b is not formed on the negative electrode current collector 25a. A negative electrode tab 26 is attached to the negative electrode uncoated portion 25c.

For reference, because a winding finish end-uncoated portion surrounds an outer side of a jelly roll-shaped electrode assembly, the winding finish end-uncoated portion performs a function of protecting the jelly roll electrode assembly. In one or more embodiments, a winding start end-uncoated portion serves as a lead for a winding core of a winding machine to hold and roll the electrode plate if the electrode assembly is wound.

In one or more embodiments, at boundaries where the positive and negative electrode tabs are drawn out from the positive electrode plate and the negative electrode plate, insulating members 27 are wound on the positive and negative electrode tabs with a width that is greater than the respective widths of the positive and negative electrode tabs to reduce or prevent the likelihood of a short circuit between the tabs and the two electrode plates.

The separator 24 is interposed between the positive electrode plate 21 and the negative electrode plate 25, and if the separator 24 is formed to have a width that is greater than those of the positive electrode plate 21 and the negative electrode plate 25, it may be suitable in reducing or preventing the likelihood of a short circuit between the electrode plates.

The positive electrode plate 21, the negative electrode plate 25, and the separator 24 of the above structure may be wound in one direction using a winder, such as a mandrel, to form the electrode assembly as shown in FIG. 1B. Adhesive tape may be attached to the outermost portion of the wound electrode assembly to reduce or prevent the likelihood of the electrode assembly from unwinding. Describing the structure of the electrode assembly in FIG. 1B, the positive electrode tab of the positive electrode plate and the negative electrode tab of the negative electrode plate are positioned at an interval (e.g., predetermined interval) in or near the center of the wound electrode assembly, and each end is drawn out to the outside.

A structure of the electrode assembly 100 for a secondary battery according to the present disclosure, in which a positive electrode tab 112 and a negative electrode tab 132 respectively protrude upwardly and downwardly from the electrode assembly 100, may be differentiated from the structure of the electrode assembly structure shown in FIGS. 1A and 1B. For example, the positive electrode tab 112 may be formed to protrude upwardly from an upper portion of the electrode assembly 100. The negative electrode tab 132 may be formed to protrude downwardly from a lower portion of the electrode assembly 100. In one or more embodiments, the positive electrode tab 112 may be formed to protrude downwardly from the lower portion of the electrode assembly. The negative electrode tab 132 may be formed to protrude upwardly from the upper portion of the electrode assembly.

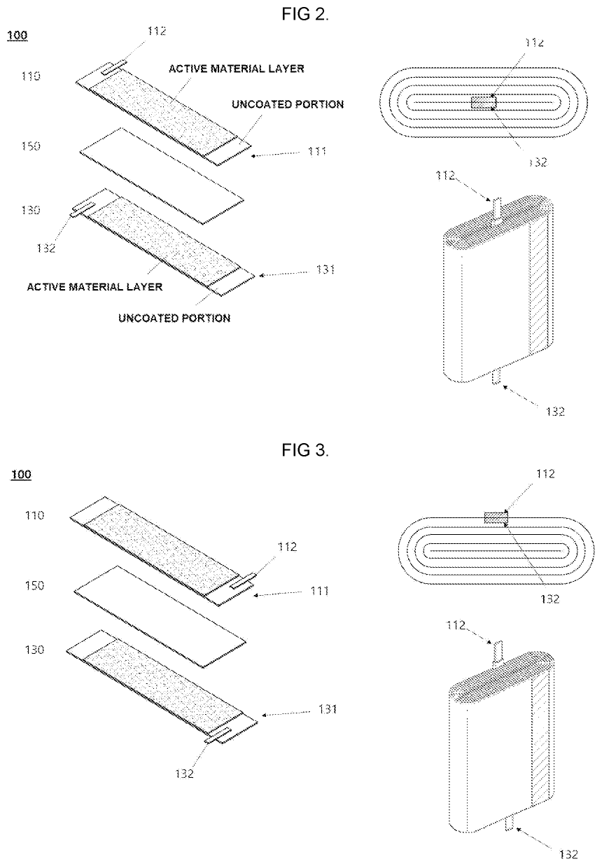

Hereinafter, the electrode assembly 100 of the present disclosure will be described in detail with reference to FIG. 2 of the one or more first embodiments of the present disclosure.

Referring to FIG. 2, the electrode assembly 100 according to the present disclosure includes a positive electrode plate 110 having a positive electrode current collector plate 111 and a positive electrode active material layer formed on at least one surface of the positive electrode current collector plate 111, includes a negative electrode plate 130 having a negative electrode current collector plate 131 and a negative electrode active material layer formed on at least one surface of the negative electrode plate 130, and includes a separator 150 interposed between the positive electrode plate 110 and the negative electrode plate 130 to insulate the electrode plates from each other.

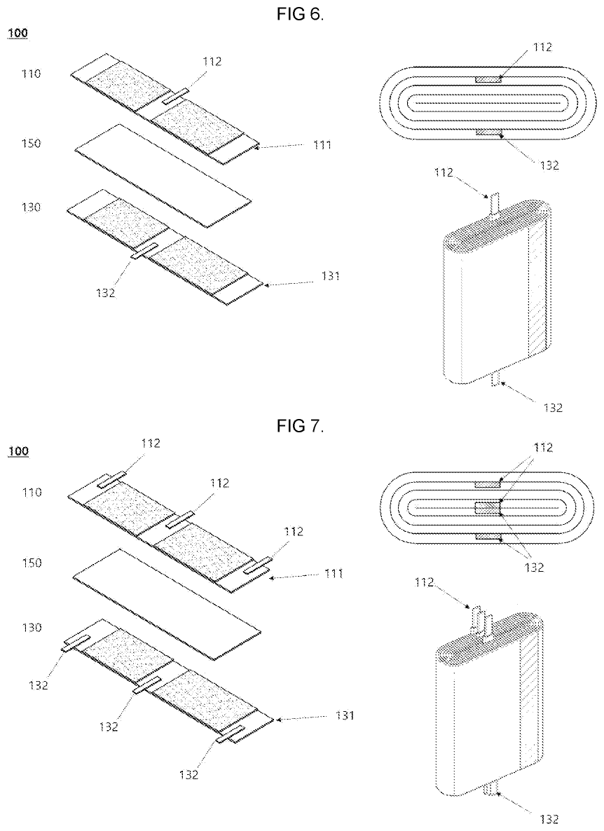

In one or more embodiments, at least one uncoated portion on which no positive electrode active material is applied is provided on the positive electrode plate 110, and at least one uncoated portion on which no negative electrode active material is applied is provided on the negative electrode plate 130. For example, as shown in FIG. 2, the positive electrode active material is applied in an area excluding both end areas (e.g., winding start and finish areas) in a winding direction of the positive electrode plate 110, and uncoated portions are provided at both ends of the positive electrode plate 110. In one or more embodiments, in the negative electrode plate 130, the negative electrode active material is applied in an area excluding both end areas in a winding direction of the negative electrode plate 130, and uncoated portions are provided at both ends of the negative electrode plate 130. In one or more embodiments, as an example, and as shown in FIG. 6, the uncoated portions may be provided not only at winding start ends and winding finish ends in the winding direction of the positive electrode plate 110 and the negative electrode plate 130, but also at the center between the uncoated portions.

In one or more embodiments, the electrode tab may be bonded to an area where a portion of the electrode plate is exposed (e.g., the uncoated portion) using a method, such as welding. For example, the positive electrode tab 112 is electrically attached and coupled to at least one of the uncoated portions of the positive electrode plate 110. The negative electrode tab 132 is electrically attached and coupled to at least one of the uncoated portions of the negative electrode plate 130. In one or more embodiments, the positive electrode tab 112 protrudes upwardly from the upper portion of the electrode assembly 100. The negative electrode tab 132 protrudes downwardly from the lower portion of the electrode assembly 100. In one or more embodiments, if the positive electrode plate 110, the separator 150, and the negative electrode plate 130 are prepared and then wound using a separately provided winder, as shown in a lower right portion of FIG. 2, a portion of the positive electrode tab 112 protrudes upwardly from the wound electrode assembly 100, and a portion of the negative electrode tab 132 protrudes downwardly from the wound electrode assembly 100.

According to the above-described configuration of the electrode assembly 100, if the electrode assembly 100 is accommodated in a space of a pouch exterior material to prepare a unit battery cell, because the electrode tabs protrude to be exposed in opposite directions of the pouch exterior material (e.g., may respectively protrude upwardly and downwardly), there may be an aspect in that electrical connection between the electrode tabs is suitable if a plurality of battery cells are located in series. Additionally, if a plurality of battery cells are connected in series, to allow the electrode tabs to be arranged and connected to corresponding electrode tabs of an adjacent battery cell at the shortest feasible distance, positions of the positive electrode tab 112 and the negative electrode tab 132 in one battery cell may be set to correspond to each other. In one or more embodiments, both the positive electrode tab 112 and the negative electrode tab 132 may be provided at the winding start end of the electrode plates or the winding finish end of the electrode plates. In one or more embodiments, because the position of the electrode tab in the wound electrode assembly 100 is located close to a position of an electrode tab of an adjacent battery cell, electrical connection work between the electrode tabs may be suitably performed.

Hereinafter, the electrode assembly 100 according to various embodiments of the present disclosure will be described in detail with reference to FIGS. 2 to 7.

FIG. 2 is a set of an exploded perspective view, and a wound cross-sectional view, of an electrode assembly 100 according to one or more first embodiments of the present disclosure. Referring to the drawing, a positive electrode tab 112 is provided in an uncoated portion at a winding start end of a positive electrode plate 110 in the winding direction. A negative electrode tab 132 is provided in an uncoated portion at a winding start end of a negative electrode plate 130 in the winding direction. According to the above-described structural aspect, as shown on the right side of FIG. 2, both the positive electrode tab 112 and the negative electrode tab 132 are provided inside the electrode assembly 100.

FIG. 3 is a set of an exploded perspective view, and a wound cross-sectional view, of an electrode assembly 100 according to one or more second embodiments of the present disclosure. Referring to the drawing, a positive electrode tab 112 is provided in an uncoated portion at a winding finish end of a positive electrode plate 110 in the winding direction. A negative electrode tab 132 is provided in an uncoated portion at a winding finish end of a negative electrode plate 130 in the winding direction. According to the above-described structural aspect, as shown on the right side of FIG. 3, both the positive electrode tab 112 and the negative electrode tab 132 are provided outside the electrode assembly 100.

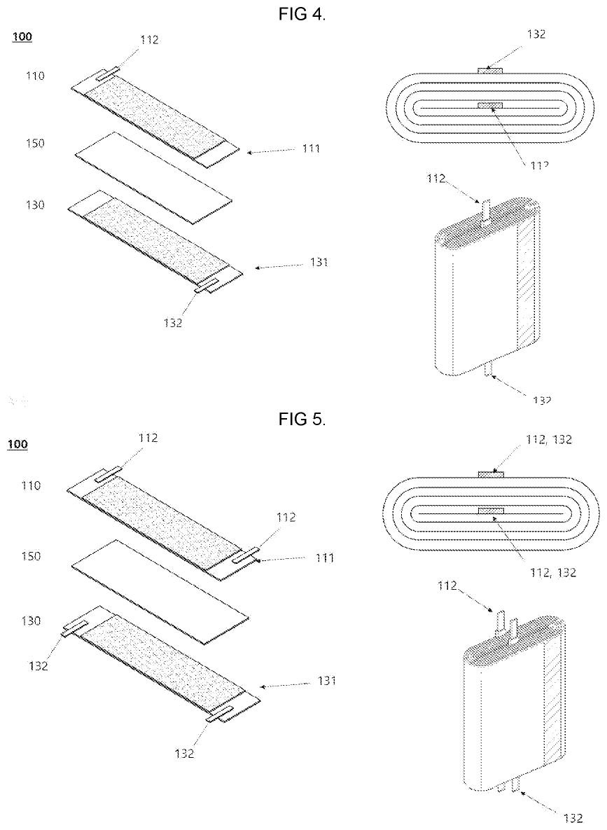

FIG. 4 is a set of an exploded perspective view, and a wound cross-sectional view, of an electrode assembly 100 according to one or more third embodiments of the present disclosure. Referring to the drawing, a positive electrode tab 112 is provided in an uncoated portion at a winding start end of a positive electrode plate 110 in the winding direction. A negative electrode tab 132 is provided in an uncoated portion at a winding finish end in the winding direction. According to the above-described structural aspect, as shown on the right side of FIG. 4, the positive electrode tab 112 is provided inside the electrode assembly 100. The negative electrode tab 132 is provided outside the electrode assembly 100.

FIG. 5 is a set of an exploded perspective view, and a wound cross-sectional view, of an electrode assembly 100 according to one or more fourth embodiments of the present disclosure. Referring to the drawing, positive electrode tabs 112 are provided in uncoated portions at a winding start end and at a winding finish end of a positive electrode plate 110 in the winding direction. Negative electrode tabs 132 are provided in uncoated portions at a winding start end and at a winding finish end of the negative electrode plate 130 in the winding direction. According to the above-described structural aspect, as shown on the right side of FIG. 5, the positive electrode tabs 112 are provided inside and outside the electrode assembly 100. The negative electrode tabs 132 are also provided inside and outside the electrode assembly 100. According to the above-described configuration, the electrode tabs are applied to both the winding start ends and the winding finish ends of the electrode plates so that there is an aspect of increasing a resistance reduction effect.

For reference, in the one or more fourth embodiments corresponding to FIG. 5, the positive electrode tabs and the negative electrode tabs may overlap in the electrode assembly after the winding, and in one or more embodiments, a base tab may be first welded to each electrode plate and an S/T (strip terminal) may be welded secondarily.

FIG. 6 is a set of an exploded perspective view, and a wound cross-sectional view, of an electrode assembly 100 according to one or more fifth embodiments of the present disclosure. Referring to the drawing, uncoated portions are provided at winding start ends and winding finish ends of a positive electrode plate 110 and of a negative electrode plate 130 in the winding direction, and also at centers between the uncoated portions, a positive electrode tab 112 is provided in the uncoated portion at the center of the positive electrode plate 110. A negative electrode tab 132 is provided in the uncoated portion at the center of the negative electrode plate 130. According to the above-described structural aspect, as shown on the right side of FIG. 6, the positive electrode tab 112 and the negative electrode tab 132 are provided at an intermediate position between the inside and outside of the electrode assembly 100.

FIG. 7 is a set of an exploded perspective view, and a wound cross-sectional view, of an electrode assembly 100 according to one or more sixth embodiments of the present disclosure. Referring to the drawing, uncoated portions are provided at winding start ends and winding finish ends of a positive electrode plate 110 and a negative electrode plate 130 in the winding direction, and also provided at centers between the uncoated portions. Positive electrode tabs 112 are provided at the winding start end, at the winding finish end, and at the center of the positive electrode plate 110. Negative electrode tabs 132 are provided at the winding start end, at the winding finish end, and at the center of the negative electrode plate 130. According to the above-described structural aspect, as shown on the right side of FIG. 7, the positive electrode tabs 112 are provided at positions inside and outside the electrode assembly 100, and at a position at the center of the electrode assembly 100. The negative electrode tabs 132 are also provided at positions inside and outside the electrode assembly 100, and at a position at the center of the electrode assembly 100. According to the above-described configuration, the electrode tabs are applied to both the winding start ends and the winding finish ends of the electrode plates so that there is an aspect of increasing a resistance reduction effect.

As described above, according to various embodiments of the present disclosure, because the connection between the electrode tabs is suitable if a plurality of battery cells are connected in series, a battery pack capable of exhibiting high voltage and high output can be suitably constructed. In one or more embodiments, a high-voltage and high-output battery pack can be suitably provided by connecting battery cells of individual units in series.

In accordance with the embodiments of the present disclosure, because electrode tabs are formed to protrude from an electrode assembly in two directions, and connection between the electrode tabs is suitable if a plurality of battery cells are connected in series, a battery pack capable of exhibiting high voltage and high output can be suitably constructed.

What has been described above are merely some embodiments for implementing an electrode assembly for a secondary battery according to the present disclosure, and the present disclosure is not limited to the above embodiments and, as described in the appended claims, with functional equivalents thereof to be included therein, the technical spirit of the present disclosure will be considered to the extent that various modifications can be made by anyone skilled in the art without departing from the gist of the present disclosure.

What is claimed is:

1. An electrode assembly for a secondary battery, comprising:
a positive electrode plate comprising:
a positive electrode current collector plate;
a positive electrode active material layer on a surface of the positive electrode current collector plate;
at least one uncoated portion at which no positive electrode active material is applied; and
at least one positive electrode tab electrically attached and coupled to the at least one uncoated portion of the positive electrode plate, and protruding upwardly from an upper portion of the electrode assembly;
a negative electrode plate comprising:
a negative electrode current collector plate;
a negative electrode active material layer on a surface of the negative electrode current collector plate;
at least one uncoated portion in which no negative electrode active material is applied;
at least one negative electrode tab electrically attached and coupled to the at least one uncoated portion of the negative electrode plate, and protruding downwardly from a lower portion of the electrode assembly; and
a separator between the positive electrode plate and the negative electrode plate.

2. The electrode assembly as claimed in claim 1, wherein the at least one uncoated portion of the positive electrode plate comprises uncoated portions respectively at a winding start end and at a winding finish end of the positive electrode plate, and
wherein the at least one uncoated portion of the negative electrode plate comprises uncoated portions respectively at a winding start end and at a winding finish end of the negative electrode plate in a winding direction.

3. The electrode assembly as claimed in claim 2, wherein the at least one positive electrode tab is at the winding start end of the positive electrode plate in the winding direction, and
wherein the at least one negative electrode tab is at the winding start end of the negative electrode plate in the winding direction.

4. The electrode assembly as claimed in claim 2, wherein the at least one positive electrode tab is at the winding finish end of the positive electrode plate in the winding direction, and
wherein the at least one negative electrode tab is at the winding finish end of the negative electrode plate in the winding direction.

5. The electrode assembly as claimed in claim 2, wherein the at least one positive electrode tab at the winding start end of the positive electrode plate in the winding direction, and
wherein the at least one negative electrode tab is at the winding finish end of the negative electrode plate in the winding direction.

6. The electrode assembly as claimed in claim 2, wherein the at least one positive electrode tab comprises positive electrode tabs respectively at the winding start end and at the winding finish end of the positive electrode plate in the winding direction, and
wherein the at least one negative electrode tab comprises negative electrode tabs respectively at the winding start end and the winding finish end of the negative electrode plate in the winding direction.

7. The electrode assembly as claimed in claim 2, wherein the at least one uncoated portion of the positive electrode plate further comprises an uncoated portion at a center of the positive electrode plate,
wherein the at least one uncoated portion of the negative electrode plate further comprises an uncoated portion at a center of the negative electrode plate,
wherein the at least one positive electrode tab is at the center of the positive electrode plate, and
wherein the at least one negative electrode tab is at the center of the negative electrode plate.

8. The electrode assembly as claimed in claim 2, wherein the at least one uncoated portion of the positive electrode plate further comprises an uncoated portion at a center of the positive electrode plate,
wherein the at least one uncoated portion of the negative electrode plate further comprises an uncoated portion at a center of the negative electrode plate,
wherein the at least one positive electrode tab comprises positive electrode tabs respectively at the winding start end, at the winding finish end, and at the center of the positive electrode plate in the winding direction, and
wherein the at least one negative electrode tab comprises negative electrode tabs respectively at the winding start end, at the winding finish end, and at the center of the negative electrode plate in the winding direction.
